(19) United States
(12) Patent Application Publication
(10) Pub. No.: US 2010/0310999 A1
(43) Pub. Date: Dec. 9, 2010

(54) COLOR FLAME CANDLE

(76) Inventor: Zhizhong Qian, Jiaude City (CN)

Correspondence Address: LEVISOHN BERGER, LLP, Suite 615, 11 Broadway, New York, NY, 10004, US

(21) Appl. No.: 12/478,276

(22) Filed: Jun. 4, 2009

(51) Int. Cl. C11C 5/00

(52) U.S. Cl. 431/288

(57) ABSTRACT

A candle that produces a pure, brilliant colorful flame. The candle incorporates a color-forming agent in its wick and not in the candle body. The localization of the color-forming agent in the wick combined with the formulation of the candle body allows for the production of a pure, colorful flame and for an extended shelf life of the candle. The candle contains primary combustion agent (87 to 100% by weight), higher fatty acid amide(0 to 12% by weight), and pigment(0 to 1% by weight). The wick includes pure cotton wick (45 to 98% by weight), color-forming agent (2 to 55% by weight).

### FIELD OF THE INVENTION

The invention relates to the field of candles, more specifically to a novel formulation of a body and wick for a color flame candle

### BACKGROUND OF THE INVENTION

Candles are commonly used to enhance joyous occasions and events by adding brilliance and creating a merry atmosphere. For example, candles ale a popular ornament or accent for decorating birthday parties, weddings, celebrations and the like.

There have been many improvements to candles over the years. For example, candles have been produced to be dripless, while others have been produced to release aromas. In the area of party candles, there have been improvements to the aesthetic appearances, such as designs and shapes. Most recently, candles have been developed that are capable of producing colorful flames. Color-flamed candles have become increasingly popular and many manufacturers have thus begun focusing attention on producing these candles in order to meet consumers' growing demand.

Instead of a standard flame as is produced by an ordinary candle, color-flamed candles produce a flame of a specific color, such as red, green, blue, purple, yellow, white etc. In older to achieve a colored flame, manufacturers typically add a color-forming agent, which usually are metal salts, into the primary combustion agent. For example, U.S. Pat. No. 6,712,865 to Lu, discloses a color-flamed candle having a color-forming agent in the candle body. However, the color flame candles produced in this fashion, though they may produce a colorful flame, the color is not pure, nor is it as brilliant as it could be. Moreover, the candles often turn musty and their quality deteriorates over a relatively short amount of time. This limited product shelf-life makes the candles unattractive to wholesalers, retailers and to end-users, who must either sell or use the same within a short window of time.

There is therefore a need in the art for a candle that produces a brilliant, pure, colorful flame, and which is capable of being stored for long periods of time without compromising the quality thereof.

### SUMMARY OF THE INVENTION

These and other advantages are realized with the color-flame candle of this invention. The candle body of comprises a combustion agent of 87-100% by weight, a higher fatty acid amide of 0-12% by weight and a pigment of 0-1% by weight. The wick comprises a pure cotton wick of 45 to 98% by weight and also comprises a color-forming agent (2-55% by weight). The localization of color agent or colorant to the candle wick, rather than to the candle body, achieves a pure, bright colorful flame. The formulation of the body allows for the integrity of the candle to remain preserved for a long period of time.

### BRIEF DESCRIPTION OF THE DRAWINGS

FIG. 1 is a front view of a lit candle according to an embodiment of the invention.

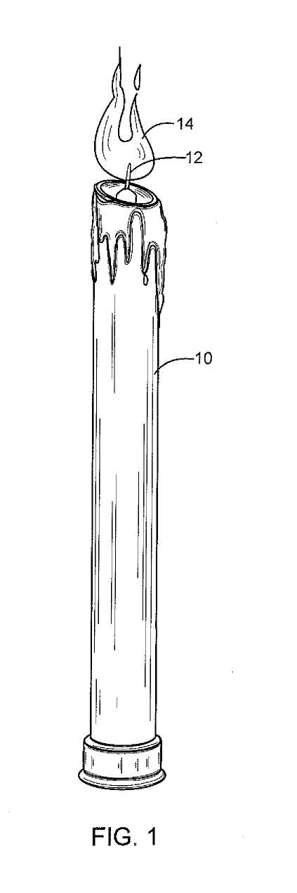

### DETAILED DESCRIPTION OF THE INVENTION

Embodiments of the present invention will now be described. However, the description herein of the invention is not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

In a preferred embodiment of the invention the body 10 of the candle is comprised of the following:

Primary combustion agent: 87 to 100% by weight

Higher fatty acid amide: 0 to 12% by weight

Pigment: 0 to 1% by weight

Because the candle body 10 contains no color-forming agent, it allows for improved integrity over prior color-flamed candles. The candle, as such, does not easily deteriorate or turn musty, as do prior color-flamed candles. Moreover, the candle body 10 does not allow for harmful oxidation reactions.

The primary combustion agent, as the main material of the candle body 10, is selected from the group consisting of paraformaldehyde, ethyl hydroxyformate, paraffin, cetesin, ethyl carbamate, sorbic anhydride, organic polybasic acid esters, polyethylene glycols, urotropine, stearic acid and vinyl acetate-ethylene copolymer—preferably ethyl carbamate and organic polybasic acid esters. The above-mentioned organic polybasic acid ester is preferably selected from the group consisting of di-C₁₋₅ alkyl oxalate, mono-C₁₋₅ alkyl succinate, tri-C₁₋₅ alkyl citrate and the trimethyl citrate (TMC). TMC is the most preferred organic polybasic acid ester.

In an embodiment of the invention, the percentage of primary combustion agent in the candle body 10 is 87 to 98% by weight, more preferably it is in the range of 90 to 97% by weight. In one preferred embodiment the primary combustion agent comprises 95% by weight, based on the total weight of the candle body 10.

The candle of the invention comprises a lubricating release agent comprising a higher fatty acid. The higher fatty acid amide is C₁₀₋₃₀fatty acid amides selected from the group consisting of decoylamide, capramide, lauramide, tridecanamide, myristamide, spetmaceti wax acid amide, stearamide and oleamide, among which, stearamide is most preferable. The percent of the higher fatty acid amide is 1 to 10% by weight, and more preferably, it is 1.5% by weight, based on the total weight of the candle body 10.

The colors of pigment include oil soluble red, oil soluble yellow, oil soluble green, oil soluble purple and oil soluble blue. Most preferably, the percentage of pigment is between 0.001 to 0.1% by weight, based on the total weight of the candle body. It will be understood by those of ordinary skill in the art that the above-mentioned pigment is provided to convey a colorful appearance to the candle body—not to color the flame produced thereby.

In addition to the above-mentioned components, the candle body 10 of the color flame candle may also include other ingredients such as, but not limited to, higher aliphatic alcohol, fatty glyceride, sucrose fatty acid ester and perfume. The details of these ingredients as well as their preferred ranges by weight will be described in turn below.

Higher aliphatic alcohol is provided as a modifier or ignition dope. Preferably it is C₁₀₋₃₀ fatty alcohols, selected from the group consisting of C₁₂, C₁₆and C₁₈ fatty alcohol or mixtures thereof. Stearyl alcohol is most preferred. The optimal percent of the higher aliphatic alcohol is 1 to 5% by weight, based on the total weight of the candle body 10.

Fatty glyceride is provided as an antioxidant and antiseptic. The fatty glyceride can be extracted from fatty acid monoglyceride, fatty acid triglyceride, fatty acid diglyceride, among which, the fatty acid monoglyceride is most preferable. The optimal percent of the fatty glyceride is 1 to 3% by weight, based on the total weight of candle body 10.

The sucrose fatty acid ester is provided as an emulsifier. The sucrose fatty acid is a C₁₀₋₃₀ fatty acid ester, among which, sucrose fatty acid ester monoester, sucrose fatty acid ester diester and sucrose fatty acid ester triglyceride are most preferable. The optimal percent of the sucrose fatty acid ester is 1 to 3% by weight, based on the total weight of candle body 10.

Perfume, which optionally may be added to convey a scent, is selected from the group consisting of lemon essence, vanilla essence, orange essence, strawberry essence and the like. The percent of the per fume is 0.001 to 0.1% by weight, based on the total weight of candle body 10. Preferably, the amount of perfume is in the range of 0.005 to 0.05%.

The color flame candle body may optionally include an accelerator to promote an oxidation reaction. Accelerators, which ate well known in the art, include vanadium pentoxide, chromic oxide and the like.

The invention also includes a novel wick formulation. In a preferred embodiment, a pure cotton wick 12 (45 to 98% by weight) is utilized, which is impregnated with a color-forming agent (2 to 55% by weight). The percent by weight is calculated on the basis of the total weight of the wick 12.

It will be understood by those of ordinary skill in the art that wicks of various materials and qualities may be utilized. However, in a preferred embodiment, a pure cotton wick is utilized. Most preferably, the cotton wick is processed by degreasing to rid impurities therefrom, in order to produce a pure and clean flame.

The inventors have found that by adding the color-forming agent to the wick 12 instead of to the candle body 10, a color flame 14 is produced that burns more brilliantly and more purely than a candle whose color-forming agent is provided in the candle body.

Preferably, the color-forming agent is an organic salt (e.g. formate, acetate and stearate) or an inorganic salt (e.g. halide including chlorid and bromid, oxychloride, nitrate, sulphate) of lithium, natrium, kalium, boron, barium, calcium, caesium, copper, magnesium or antimony, and mixtures or complexes of the above-mentioned metals. The percent of color-forming agent is 2 to 10% by weight, but more preferably it is 2 to 5% by weight, based on the total weight of its wick 12.

To summarize the above-described preferred embodiment of the invention, the components of the candle body 10 are:

| | |
|---|---|
| primary combustion agent | 87 to 100% |
| higher fatty acid amide | 0 to 12% |
| pigment | 0 to 1% |

Note: the percent by weight is calculated on the basis the total weight of the candle body 10.

The components of the wick 10 are:

| | |
|---|---|
| Pure cotton wick | 45 to 98% |
| Color forming agent | 2 to 55% |

Note: the percent by weight is calculated on the basis the total weight of the wick 12.

Color flame candles produced by the methods and formulations of this invention remain fresh and preserved for extended periods of time and they are not easily susceptible to becoming musty or to otherwise deteriorating in quality. In addition to an extended shelf-life, these candles produce a pure, colorful flame that burns brightly and brilliantly.

### ILLUSTRATIVE EXAMPLES

Example I

### Red Flame Candle

### Composition of Candle Body:

| | |
|---|---|
| Trimethyl citrate | 98% |
| Stearamide | 1.5% |
| Oil soluble red | 0.5% |

### Composition of Wick:

| | |
|---|---|
| Pure cotton wick | 95% |
| Lithium propionic acid (CH₃CH₂COOLi) | 5% |

The candle is prepared in the following manner. The above-mentioned ingredients, which comprise the candle body, are heated into a molten mixture under a condition of 90 to 95 centigrade. The resultant molten mixture is then poured into a candle making mold containing a wick impregnated with oil soluble red. In order to impregnate the wick, it is immersed with lithium propionic acid for roughly 10 minutes and then air-dried. After the molten mixture cools, it is depanned and ready for packaging.

### Example II

### Purple Flame Candle

### Composition of Candle Body:

| | |
|---|---|
| Trimethyl citrate | 95% |
| Stearamide | 4.5% |
| Oil soluble purple | 0.5% |

### Composition of Wick:

| | |
|---|---|
| Pure cotton wick | 60% |
| Lithium chloride | 40% |

The candle is prepared according to the methods described in example I

### Example III

### Yellow Flame Candle

### Composition of Candle Body:

| | |
|---|---|
| Trimethyl citrate | 87% |
| Stearamide | 12% |
| Oil soluble yellow | 1% |

### Composition of Wick:

| | |
|---|---|
| Pure cotton wick | 98% |
| Sodium citrate | 2% |

The candle is prepared according to the methods described in example I

### Results of Candle Storage Experiments

In order to test the shelf-life of the candles, representative candles from among candles produced in accordance with Examples 1-3 above, were stored according to the following conditions:
Temperature: 20±2° C.
Relative humidity: 65±5%
Length of the period: 12 months

A number of prior art candles (having color forming agents in the candle body only) were stored under the same conditions for comparison purposes.

The following table compares the conditions of candles of the current invention with those of the prior art after 12 months of storage:

| Color Flame | | | | Prior Art Color |
|---|---|---|---|---|
| Candle | Example I | Example II | Example III | Flame Candle |
| Musty | not present | not present | not present | present |
| Condition | | | | |
| Deteriorating | none | none | none | After 10 5 |
| Condition | | | | months |

Note:
the prior art color flame candle is a candle comprising color-forming agent in the candle body.

As demonstrated, the inventive candle retains its integrity for a longer period of time than the prior art candles. After 12 months of storage, the inventive candles did not show any signs of being musty, stale, or of any other deteriorating condition. This is contrasted with the prior art candles, which after the same test period showed physical signs of deterioration, such as becoming soft and moist. As indicated in the chart, deteriorating conditions were observed as early as 10.5 months after beginning of storage.

### Results of Comparative Burning Tests

The purity of the flame color of representative samples of the three examples of candles mentioned above were compared to the flame color of a prior art candle.

The results are shown as follows:

| Color Flame | | | | Prior Art Color |
|---|---|---|---|---|
| Candle | Example I | Example II | Example III | Flame Candle |
| Purity of | pure | pure | pure | not pure |
| Flame Color | | | | |

As demonstrated, the candle of the current invention produces a color that is more pure than the color flames produced with the prior art candles. Color flame purity refers to a flame that is purely the intended color and contains little or no natural fire color. For example, a red flame colored candle produced in accordance with the current invention (such as according to Example 1 herein), will produce a flame that is entirely or almost entirely red. A red flame colored candle of the prior art, however, will contain colors associated with natural flame combined with the red flame.

Having described this invention with regard to specific embodiments, it is to be understood that the description is not meant as a limitation since further modifications and variations may be apparent or may suggest themselves to those skilled in the art. It is intended that the present application cover all such modifications and variation as fall within the scope of the appended claims.

What is claimed is:

1. A color flamed candle, comprising:
a body comprising a primary combustion agent;
a wick impregnated with a color-forming agent disposed in said primary combustion agent.

2. The candle of claim 1, wherein said body comprises:
primary combustion agent: 87 to 100% by weight;
higher fatty acid amide: 0 to 12% by weight; and
pigment: 0 to 1% by weight.

3. The candle of claim 1, wherein said primary combustion agent is selected from the group consisting of paraformaldehyde, ethyl hydroxyformate, paraffin, ceresin, ethyl carbamate, sorbic anhydride, organic polybasic acid esters, polyethylene glycols, urotropine, stearic acid and vinyl acetate-ethylene copolymer resins.

4. The candle of claim 1, wherein said primary combustion agent is in the range of 87 to 98% by weight.

5. The candle of claim 1, wherein said primary combustion agent is in the range of 90 to 97% by weight.

6. The candle of claim 1, wherein said primary combustion is 95% by weight.

7. The candle of claim 3, wherein said organic polybasic acid esters is selected from the group consisting of di-C₁₋₅ alkyl oxalate, mono-C₁₋₅ alkyl succinate, tri-C₁₋₅ alkyl citrate and trimethyl citrate (TMC).

8. The candle of claim 2, wherein said higher fatty acid amide is C₁₀₋₃₀fatty acid amide is selected from the group consisting of decoylamide, capramide, lauramide, tridecanamide, myristamide, spermaceti wax acid amide, stearamide and oleamide. And commonly the percent of the higher fatty acid amide is 1 to 10% by weight, and better percent is 1.5% by weight, based on the total weight of the candle body.

9. The candle of claim 2, wherein said fatty acid amide is in the range of 1 to 10% of the total weight of the candle.

10. The candle of claim 2, wherein said fatty acid amide is in the range of 1 to 10% of the total weight of the candle.

11. The candle of claim 2, wherein said fatty acid amide is 1.5% of the total weight of the candle.

12. The candle of claim 2, wherein said pigment is selected from the group consisting of oil soluble red, oil soluble yellow, oil soluble green and oil soluble blue.

13. The candle of claim 1, wherein said body further comprises at least one of higher aliphatic alcohol, fatty glyceride, sucrose fatty acid ester and perfume.

14. The candle of claim 2, wherein said wick comprises:
a pure cotton wick, wherein said pure cotton wick is in the range of 45 to 98% of the total weight of the wick; and
color-forming agent, wherein said color-forming agent is in the range of 2 to 55% of the total weight of the wick.

15. The candle of claim 14, wherein said color-forming agent is selected from the group consisting of organic salts of lithium, inorganic salts of lithium, natrium, kalium, boron, barium, calcium, caesium, copper, magnesium and antimony, and any combination thereof.

16. The candle of claim 14, wherein said color-forming agent is in the range of 2 to 10% of the total weight of the wick.

17. The candle of claim 14, wherein said color-forming agent is in the range of 2 to 5% of the total weight of the wick.

18. A wick comprising:
a pure cotton wick, wherein said pure cotton wick is in the range of 45 to 98% of the total weight of the wick; and
color-forming agent, wherein said color-forming agent is in the range of 2 to 55% of the total weight of the wick.

19. The wick of claim 18, wherein said color-forming agent is selected from the group consisting of organic salts of lithium, inorganic salts of lithium, natrium, kalium, boron, barium, calcium, caesium, copper, magnesium and antimony, and any combination thereof.

20. The wick of claim 18, wherein said wick has been degreased to remove impurities. 13
